(19) United States
(12) Patent Application Publication
(10) Pub. No.: US 2011/0118121 A1
(43) Pub. Date: May 19, 2011

(54) NOVEL SOLVENTS FOR 2,4-D ACID AND ACID PLANT GROWTH REGULATORS

(75) Inventor: Jinxia Susan Sun, Hopewell Junction, NY (US)

(73) Assignee: AKZO NOBEL N.V., Arnhem (NL)

(21) Appl. No.: 13/002,807

(22) PCT Filed: Jul. 3, 2009
(86) PCT No.: PCT/EP2009/058381

§ 371 Date: Jan. 6, 2011

Related U.S. Application Data
(60) Provisional application No. 61/078,912, filed on Jul. 8, 2008.

(30) Foreign Application Priority Data
Sep. 9, 2008 (EP) 08163975.9

(51) Int. Cl. A01N 39/02; A01N 25/02; A01P 21/00

(52) U.S. Cl. 504/323; 504/362

(57) ABSTRACT

The invention relates to a method of solubilizing a plant growth regulating agent, and method comprising contacting said agricultural active with a solubilizing effective amount of at least one solubilizing agent, wherein said solubilizing agent comprises at least one alkyl quaternary ammonium surfactant, or at least one alkoxylated quaternary ammonium surfactant, or a mixture thereof. Plant growth regulating formulations are also claimed.

### FIELD OF INVENTION

The invention generally relates to novel solvents for 2,4-D acid and plant growth regulating acids and to methods for preparing formulations containing them.

### BACKGROUND OF THE INVENTION

Many agricultural formulations contain actives such as herbicide or plant growth regulators (PGR's) in their acid form. The solubility of these acids is normally very low in both polar and non-polar solvents. Typically, in order to more easily solubilize these actives, they are conversed into their ester or salt form by further chemical reaction. However these added steps increase formulation costs and acid loading in the final formulations is typically lowed.

Another common way is to dissolve these actives at low level in alcohol. Isopropanol is commonly used as the solvent. The disadvantage of this approach is that the resulting formulation is highly flammable, creating storage and safety issues for users.

2,4-dichlorophenoxyacetic acid (2,4-D) and its non-amine salts have very low solubility in water. Because of this, the most commonly used 2,4-D herbicide is 2,4-D amine salts. Although hydrophobic 2,4-D esters are available, 2,4-D formulated and applied as a water-soluble salt has the added advantages of not requiring an emulsifier and/or an organic solvent.

Accordingly, it is an object of the invention to provide a formulation of 2,4-D acid or the acid of plant growth regulators in a non-flammable formulation, which is stable and cost effective.

### SUMMARY OF THE INVENTION

The present inventors have surprisingly discovered that 2,4-D acid and many plant growth regulating acids can be dissolved very effectively in a certain class of surfactants. More specifically, it has been surprisingly discovered that certain surfactants, i.e., alkoxylated quaternary surfactants and alkyl quaternary surfactants are extremely effective and useful in solubilizing 2,4-D acid or acid plant growth regulators. Additionally, the surfactants of the invention improve formulation cost, allow high acid loading and improve storage stability, and the formulations no longer flammable, in that they have flash points over 200° F.

In one embodiment, the invention contemplates a formulation comprising at least one of 2,4-D acid or acid plant growth regulator and at least one alkoxylated quaternary surfactant, or alkyl quaternary surfactants surfactant in an effective amount such that said acid is dissolved in the surfactant and said at least one surfactant is present in a quantity 10 to 70% in the composition.

The invention also relates to a process for preparing a composition which comprises 2,4-D acid or acid plant growth regulator solubilized with the surfactants contemplated herein, and to a method for solubilizing same.

### DETAILED DESCRIPTION OF THE INVENTION

The present generally relates to a method of solubilizing 2,4-D acid and/or plant growth regulating acids with certain alkoxylated quaternary surfactants and/or alkyl quaternary surfactants. The invention also relates to agricultural formulations comprising 2,4-D and or plant growth regulating acids solubilized with certain alkoxylated quaternary surfactants and/or alkyl quaternary surfactants of the invention. These surfactants are surprisingly effective and useful in solubilizing 2,4-D acid and/or acid plant growth regulators, while at the same time improving formulation cost and storage stability and allowing high acid loading. The flash points of the formulations are over 200° F., which is also a dramatic improvement in flammability.

Acid plant growth regulators that are relatively insoluble in water, but can be readily solubilized by the surfactants of the invention include, but are not limited by: Synthetic auxins including, but not limited to Indole acetic acids, Indole butyric acids, Giberrelic acids, Naphthalene acetic acids, Cytokinins, Abscisic acid and the like.

The surfactants of the invention that have been found to be particularly useful include alkoxylated quaternary surfactants and alkyl quaternary surfactants. The alkoxylated quaternary surfactants that are useful in the context of the present invention are represented by the formula:

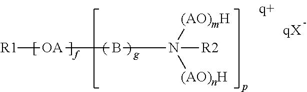

wherein R1 is a straight or branched chain, saturated or unsaturated alkyl group having from 8 to 22 carbon atoms; R2 is a hydrogen and/or a straight or branched chain alkyl group having from 1 to 4 carbon atoms; A is CₓH₂ₓ where x is 2 to 4; B is C_{y}H_{2y} where y is 2 to 6; X⁻ is a compatible anion such as methyl sulfate or chloride, f is zero to 10; m and n is an integer of from 0-30 with the proviso that m+n is at least 1, p is 1 to 7 and g can be any number from zero to 6 for each p and independent of p, and q is 1 to 7 with a provision that p may be greater than q. In one embodiment, the A is C₂H₄, f=0, and g=0. In another embodiment, the A is C₂H₄, f=0, g=0, m+n is 1 to 20, R2 is methyl group, p=1, q=1, and X is chloride.

Alkoxylated quaternary surfactants having utility in the context of the invention include, but are not limited to:
Octadecylmethylbis(2-hydroxyethyl)ammonium chloride (Ethoquad® 18/12)
Octadecylmethyl[polyoxyethylene (15)] ammonium chloride (Ethoquad® 18/25)
Cocoalkylmethylbis(2-hydroxyethyl)ammonium chloride (Ethoquad® C/12)
Cocoalkylmethylbis(2-hydroxyethyl)ammonium nitrate (Ethoquad® C/12 Nitrate)
Benzylbis(2-hydroxyethyl)cocoalkyl ammonium chloride (Ethoquad®C/128)
Cocoalkylmethyl[polyoxyethylene (15)] ammonium (Ethoquad® C/25)
Oleylmethylbis(2-hydroxyethyl)ammonium (Ethoquad® O/12)
Oleylmethylbis(2-hydroxyethyl)ammonium (Ethoquad® O/12H)
Oleylmethyl[polyoxyethylene (15)] ammonium (Ethoquad® O/25)
Tallowalkylmethybis(2-hydroxyethyl)ammonium (Ethoquad® T/12 E)
Tris(2-hydroxyethyl)tallowalkyl ammonium (Ethoquad® T/13-27W)
   Ethoquad® is a registered trademark of Akzo Nobel Surface Chemistry LLC and/or one of its affiliates.

The following alkyl quaternary surfactants are useful in the context of the present invention:

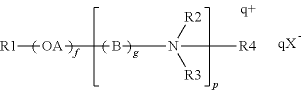

wherein R1 is a straight or branched chain, saturated or unsaturated alkyl group having from 8 to 22 carbon atoms. R2 is a hydrogen and/or a straight or branched chain alkyl group having from 1 to 4 carbon atoms, R3 and R4 is independently a straight or branched chain alkyl group having from 1 to 4 carbon atoms, A is CₓH₂ₓ where x is 2 to 4; B is C_{y}H_{2y} where y is 2 to 6; and X⁻ is a compatible anion such as methyl sulfate or chloride. f is zero to 10; p is 1 to 7 and g can be any number from zero to 6 for each p and independent of p, and q is 1 to 7 with a provision that p may be greater than q. In one embodiment, the A is C₂H₄, f=0, and g=0. In another embodiment, the A is C₂H₄, f=0, g=0, R2 is methyl group, R3 is a methyl group, R4 is a methyl group, p=1, q=1, and X is chloride.

Alkyl quaternary surfactants having utility in the context of the present invention include, but are not limited to:
Octadecylmethylbis(2-hydroxyethyl)ammonium chloride (Ethoquad® 18/12)
Octadecylmethyl[polyoxyethylene (15)] ammonium chloride (Ethoquad® 18/25)
Cocoalkylmethylbis(2-hydroxyethyl)ammonium chloride (Ethoquad®C/12)
Cocoalkylmethylbis(2-hydroxyethyl)ammonium nitrate (Ethoquad® C/12 Nitrate)
Benzylbis(2-hydroxyethyl)cocoalkyl ammonium chloride (Ethoquad® C/12B)
Cocoalkylmethyl[polyoxyethylene (15)] ammonium (Ethoquad® C/25)
Oleylmethylbis(2-hydroxyethyl)ammonium (Ethoquad® O/12)
Oleylmethylbis(2-hydroxyethyl)ammonium (Ethoquad® O/12 t)
Oleylmethyl[polyoxyethylene (15)] ammonium (Ethoquad® O/25)
Tallowalkylmethybis(2-hydroxyethyl)ammonium (Ethoquad® T/12 E)
Tris(2-hydroxyethyl)tallowalkyl ammonium (Ethoquad® T/13-27W)

Typically, the formulations of the invention are formulated such that they comprise at least 2,4-D acid and/or one or more additional acid plant growth regulators and at least one surfactant in accordance with the invention in an effective amount such that said 2,4-D acid and/or acid plant growth regulator is dissolved in the surfactant and said at least one surfactant is present in a quantity 10 to 70 wt. % based on that of the final formulation.

2,4-D is a known herbicide, but at lower concentration rates it can also be used as plant growth regulator. The content of active ingredients might be varied which is depended on the chemical properties of the active ingredients. When the formulation is used as plant growth regulators, it is possible to have a formulation comprising different kinds of growth regulators i.e. 2,4-D acid and another plant regulator. However, when 2,4-d acid is used as a herbicide rather than a grow regulator, the formulation typically will not containing another plant growth regulator.

Plant growth regulating acids include, but are not limited to the acid forms of: synthetic auxins including, but not limited to: indole acetic acids, indole butyric acids, giberrelic acids naphthalene acetic acids, cytokinins, abscisic acid and mixtures and combinations thereof.

The formulations of the invention may also contain certain oil-based components. The oil or oil substitutes include, but are not limited to:
i. Alkylated fatty acid esters, including but are not limited to methylated fatty acids, including but not limited to methylated C₆-C₁₉ fatty acids, methylated Tall oil fatty acids, methylated Oleic acid, methylated Linoleic acid, methylated Linolenic acid, methylated Stearic acid, methylated palmitic acid, and blends thereof;
ii. Ethylated fatty acids, including but are not limited to: ethylated C₆-C₁₉ fatty acids, ethylated Tall oil fatty acids, ethylated oleic acid, ethylated linoleic acid, ethylated linolenic acid, ethylated stearic acid, ethylated palmitic acid, and blends thereof;
iii. Butylated fatty acids, including but are not limited to: butylated C₆-C₁₉ fatty acids, butylated Tall oil fatty acids, butylated oleic acid, butylated linoleic acid, butylated linolenic acid, butylated stearic acid, butylated palmitic acid, and blends thereof,
iv. Alkylated natural oils, including but are not limited to: alkylated soybean oil, including but limited to: methylated soybean oil, ethylated soybean oil, butylated soybean oil, and blends thereof; alkylated canola oil, including but are not limited to: methylated canola oil, ethylated canola oil, butylated canola oil, and blends thereof; alkylated coconut oil, including but are not limited to: methylated coconut oil, ethylated coconut oil, butylated coconut oil, and blends thereof; alkylated sunflower oil, including but are not limited to: methylated sunflower oil, ethylated sunflower oil, butylated sunflower oil, and blend thereof;
v. Hydrocarbon oils including but are not limited to: mineral oils, including but are not limited to: paraffinic mineral oils, naphthenic mineral oils, aromatic mineral oils, and blends thereof; vegetable oils, including but are not limited to: soybean oil, canola oil, cottonseed oil, and blends thereof;
vi. Fatty acids, including but are not limited to: C₆-C₁₉ fatty acids, Tall oil fatty acids, oleic acid, linoleic acid, linolenic acid, stearic acid, palmitic acid, and blends thereof; p-olybutenes
vii. Epoxified seed oils including but are not limited to: epoxified soybean oil and
viii. Other oils or oil substitutes known to the skilled artisan.

The formulation can contain one or more of the above oils or its equivalent. The oil can also be a blend of at least two oils. When oil is used in the formulation, a surfactant or emulsifier must also be used if the composition is intended for aqueous based sprays.

In one embodiment, the invention relates to an agricultural formulation comprising:
(a) from about 1 to about 50% by weight of at least one 2,4-D acid and/or acid plant growth regulator, in another embodiment from about 1 to about 45% and in still another embodiment from about 15 to about 40%;
(b) at least about 10% of an alkyl and/or alkoxylated quaternary surfactant; in another embodiment at least 20% by weight of said surfactant, in another embodiment at least 25% by weight of said surfactant, in another embodiment at least 30% by weight of said surfactant, in another embodiment at least 40% by weight of said surfactant and in another embodiment at least 50% by weight of said surfactant.
(c) Optionally other components.

The surfactant(s) of the invention are included in an amount effective to solubilize the 2,4-D acid and/or acid plant growth regulator contained in the formulation. Generally, this amount is from about 8 to about 99%, in another embodiment from about 50 to about 90%, and in another embodiment from about 95 to about 98% by weight based on the total weight of the formulation. Typically, the ratio of 2,4-D acid and/or acid plant growth to surfactant in formulations of the invention is from about 1:6 to about 1:1.

Formulations of the invention containing 2,4-D acid or acid plant growth regulator can optionally contain other solvents such as water and/or one or more aromatic solvents. If additional solvents are included, it is preferred that they be included in amounts of from 0 to 50% by weight, in another embodiment at most 35% by weight and in still another embodiment at most 30% by weight.

The invention will now be illustrated by the following non-limiting examples.

### Example 1

| | |
|---|---|
| 2,4-D acid | 40.0% |
| Tallowamine-15EO methyl chloride. | 60.0% |

### Example 2

| | |
|---|---|
| 2,4-D acid | 33.3% |
| Tallowamine-15EO methyl chloride. | 33.3% |
| Water | 33.4% |

### Example 3

| | |
|---|---|
| 2,4-D acid | 40.0% |
| Tallowamine-15EO methyl chloride. | 30.0% |
| Alcohol ethoxylated (branched C10 3 EO) | 30.0% |

In all of the above examples, the components are blended together and the technical dissolved entirely. The solution formed contains less than 2% of precipitates in the example 2 and in the case of example 1 and 3 which showed 0% precipitates.

One of ordinary skill in the art would recognize that various modifications within the spirit and scope of the invention can be made. For example, one could readily formulate pesticides in accordance with the invention, and fertilizers could be added to the formulations of the invention without deviating from the scope thereof.

All references discussed herein are incorporated by reference in their entirety for all useful purposes.

We claim:

1. A plant growth regulator formulation comprising at least one solubilizing agent and at least one plant growth regulating active ingredient solubilized therein, wherein said solubilizing agent comprises at least one alkyl quaternary ammonium surfactant, or at least one alkoxylated quaternary ammonium surfactant, or mixtures thereof.

2. The formulation of claim 1 wherein said plant growth regulator comprises the acid form of at least one of synthetic auxins.

3. The formulation of claim 1 wherein said synthetic auxin is chosen from indole acetic acids, indole butyric acids, giberrelic acids, naphthalene acetic acids, cytokinins, abscisic acid and mixtures and combinations thereof.

4. The formulation of claim 1 wherein said alkoxylated quaternary ammonium surfactant is of the general formula: 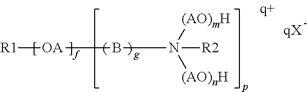
wherein R1 is a straight or branched chain, saturated or unsaturated alkyl group having from 8 to 22 carbon atoms; R2 is a hydrogen and/or a straight or branched chain alkyl group having from 1 to 4 carbon atoms; A is CₓH₂ₓ where x is 2 to 4; B is C_{y}H_{2y} where y is 2 to 6; X⁻ is a compatible anion such as methyl sulfate or chloride, f is zero to 10; m and n is an integer of from 0-30 with the proviso that m+n is at least 1, p is 1 to 7 and g can be any number from zero to 6 for each p and independent of p, and q is 1 to 7 with a provision that p may be greater than q.

5. The formulation of claim 4 wherein A is C₂H₄, f=0, g=0, m+n is 1 to 20, R2 is a methyl group, p=1, and X− is chloride.

6. The formulation of claim 4 wherein said alkoxylated quaternary ammonium surfactant is chosen from Octadecylmethylbis(2-hydroxyethyl)ammonium chloride (Ethoquad® 18/12), Octadecylmethyl[polyoxyethylene (15)] ammonium chloride (Ethoquad® 18/25), Cocoalkylmethylbis(2-hydroxyethyl)ammonium chloride (Ethoquad® C/12), Cocoalkylmethylbis(2-hydroxyethyl)ammonium nitrate (Ethoquad® C/12 Nitrate), Benzyl bis(2-hydroxyethyl)cocoalkyl ammonium chloride (Ethoquad® C/12B), Cocoalkylmethyl[polyoxyethylene (15)] ammonium (Ethoquad® C/25), Oleylmethylbis(2-hydroxyethyl)ammonium (Ethoquad® O/12), Oleylmethylbis(2-hydroxyethyl)ammonium (Ethoquad® O/12H), Oleylmethyl[polyoxyethylene (15)] ammonium (Ethoquad® O/25), Tallowalkylmethybis(2-hydroxyethyl)ammonium (Ethoquad® T/12 E), Tris(2-hydroxyethyl)tallowalkyl ammonium (Ethoquad® T/13-27W), or mixtures or combinations thereof.

7. The formulation of claim 1 wherein said alkyl quaternary surfactant is of the formula 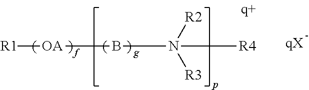
wherein R1 is a straight or branched chain, saturated or unsaturated alkyl group having from 8 to 22 carbon atoms. R2 is a hydrogen and/or a straight or branched chain alkyl group having from 1 to 4 carbon atoms, R3 and R4 is independently a straight or branched chain alkyl group having from 1 to 4 carbon atoms, A is CₓH₂ₓ where x is 2 to 4; B is C_{y}H_{2y} where y is 2 to 6; and X⁻ is a compatible anion such as methyl sulfate or chloride. f is zero to 10; p is 1 to 7 and g can be any number from zero to 6 for each p and independent of p, and q is 1 to 7 with a provision that p may be greater than q.

8. The formulation of claim 7 wherein A is C₂H₄, f=0, and g=0.

9. The formulation of claim 7 wherein A is C₂H₄, f=0, g=0, R2 is methyl group, R3 is a methyl group, R4 is a methyl group, p=1, and X is chloride.

10. The formulation of claim 1 wherein said alkyl quaternary surfactant is chosen from Octadecylmethylbis(2-hydroxyethyl)ammonium chloride (Ethoquad® 18/12), Octadecylmethyl[polyoxyethylene (15)] ammonium chloride (Ethoquad® 18/25), Cocoalkylmethylbis(2-hydroxyethyl)ammonium chloride (Ethoquad® C/12), Cocoalkylmethylbis(2-hydroxyethyl)ammonium nitrate (Ethoquad® C/12 Nitrate), Benzylbis(2-hydroxyethyl)cocoalkyl ammonium chloride (Ethoquad® C/12B), Cocoalkylmethyl[polyoxyethylene (15)] ammonium (Ethoquad® C/25), Oleylmethylbis(2-hydroxyethyl)ammonium (Ethoquad® O/12), Oleylmethylbis(2-hydroxyethyl)ammonium (Ethoquad® O/12H), Oleylmethyl[polyoxyethylene (15)] ammonium (Ethoquad® O/25), Tallowalkylmethybis(2-hydroxyethyl)ammonium (Ethoquad® T/12 E), Tris(2-hydroxyethyl)tallowalkyl ammonium (Ethoquad® T/13-27W), or mixtures or combinations thereof.

11. The formulation of claim 1 wherein the total amount of said solubilizing agent is from about 10 to about 70% by weight and said plant growth regulating active ingredient is present in an amount from about 1 to about 50% by weight, based on the weight of the total formulation.

12. The formulation of claim 1, which further comprises a solvent present in an amount 1 to 50% by weight.

13. The formulation of claim 1 wherein said plant growth regulator is 2,4-D acid.

14. The formulation of claim 1 wherein the ratio of said plant growth regulating active to said solubilizing agent is from about 1:6 to about 1:1.

15. A method of solubilizing a plant growth regulating active selected, and method comprising contacting said agricultural active with a solubilizing effective amount of at least one solubilizing agent, wherein said solubilizing agent comprises at least one alkyl quaternary ammonium surfactant, or at least one alkoxylated quaternary ammonium surfactant, or a mixture thereof.

16. The method of claim 15 wherein said plant growth regulator is selected from indole acetic acid, indole butyric acid, giberrelic acid, naphthalene acetic acid, cytokinin, abscisic acid, and mixtures thereof.

17. The method of claim 15 wherein said alkoxylated quaternary ammonium surfactant is of the general formula: 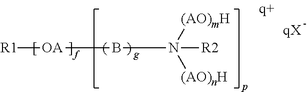
wherein R1 is a straight or branched chain, saturated or unsaturated alkyl group having from 8 to 22 carbon atoms; R2 is a hydrogen and/or a straight or branched chain alkyl group having from 1 to 4 carbon atoms; A is CₓH₂ₓ where x is 2 to 4; B is C_{y}H_{2y} where y is 2 to 6; X⁻ is a compatible anion such as methyl sulfate or chloride, f is zero to 10; m and n is an integer of from 0-30 with the proviso that m+n is at least 1, p is 1 to 7 and g can be any number from zero to 6 for each p and independent of p, and q is 1 to 7 with a provision that p may be greater than q.

18. The method of claim 17 wherein A is C₂H₄, f=0, and g=0.

19. The method of claim 17 wherein A is C₂H₄, f=0, g=0, m+n is 1 to 20, R2 is a methyl group, p=1, and X− is chloride.

20. The method of claim 17 wherein said alkoxylated quaternary ammonium surfactant is chosen from Octadecylmethylbis(2-hydroxyethyl) ammonium chloride (Ethoquad® 18/12), Octadecylmethyl[polyoxyethylene (15)] ammonium chloride (Ethoquad® 18/25), Cocoalkylmethylbis(2-hydroxyethyl)ammonium chloride (Ethoquad® C/12), Cocoalkylmethylbis(2-hydroxyethyl)ammonium nitrate (Ethoquad® C/12 Nitrate), Benzylbis(2-hydroxyethyl)cocoalkyl ammonium chloride (Ethoquad® C/12B), Cocoalkylmethyl[polyoxyethyl (15)] ammonium (Ethoquad® C/25), Oleylmethylbis(2-hydroxyethyl)ammonium (Ethoquad® O/12), Oleylmethylbis(2-hydroxyethyl)ammonium (Ethoquad® O/12H), Oleylmethyl[polyoxyethylene (15)] ammonium (Ethoquad® O/25), Tallowalkylmethybis(2-hydroxyethyl)ammonium (Ethoquad® T/12 E), Tris(2-hydroxyethyl)tallowalkyl ammonium (Ethoquad® T/13-27W), or mixtures or combinations thereof.

21. The method of claim 17 wherein said alkyl quaternary surfactant is of the formula 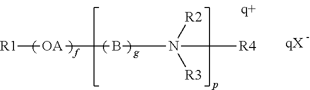
wherein R1 is a straight or branched chain, saturated or unsaturated alkyl group having from 8 to 22 carbon atoms. R2 is a hydrogen and/or a straight or branched chain alkyl group having from 1 to 4 carbon atoms, R3 and R4 is independently a straight or branched chain alkyl group having from 1 to 4 carbon atoms, A is CₓH₂ₓ where x is 2 to 4; B is C_{y}H_{2y} where y is 2 to 6; and X⁻ is a compatible anion such as methyl sulfate or chloride. f is zero to 10; p is 1 to 7 and g can be any number from zero to 6 for each p and independent of p, and q is 1 to 7 with a provision that p may be greater than q.

22. The method of claim 17 wherein A is C₂H₄, f=0, g=0, R2 is methyl group, R3 is a methyl group, R4 is a methyl group, p=1, and X is chloride.

23. The method of claim 21 wherein said alkyl quaternary surfactant is chosen from Octadecylmethylbis(2-hydroxyethyl)ammonium chloride (Ethoquad® 18/12), Octadecylmethyl[polyoxyethylene (15)] ammonium chloride (Ethoquad® 18/25), Cocoalkylmethylbis(2-hydroxyethyl)ammonium chloride (Ethoquad® C/12), Cocoalkylmethylbis(2-hydroxyethyl)ammonium nitrate (Ethoquad® C/12 Nitrate), Benzylbis(2-hydroxyethyl)cocoalkyl ammonium chloride (Ethoquad® C/12B); Cocoalkylmethyl[polyoxyethylene (15)] ammonium(Ethoquad® C/25), Oleylmethylbis(2-hydroxyethyl)ammonium (Ethoquad® O/12); Oleylmethylbis(2-hydroxyethyl)ammonium (Ethoquad® O/12H), Oleylmethyl[polyoxyethylene (15)] ammonium Ethoquad® O/25), Tallowalkylmethybis(2-hydroxyethyl)ammonium (Ethoquad® T/12 E), Tris(2-hydroxyethyl)tallowalkyl ammonium (Ethoquad® I/13-27W), or mixtures or combinations thereof.

24. The method of claim 15 wherein the total amount of said at least one solubilizing agent is from about 10 to about 70% by weight said herbicidally active ingredient is present in an amount from about 1 to about 50% by weight, based on the weight of the total formulation.

25. The method of claim 15 wherein the ratio of said agricultural active to said solubilizing agent is from about 1:6 to about 1:1.
